(19) United States
(12) Patent Application Publication
(10) Pub. No.: US 2013/0091101 A1
(43) Pub. Date: Apr. 11, 2013

(54) SYSTEMS AND METHODS FOR NETWORK ASSISTED FILE SYSTEM CHECK

(71) Applicants: Farshid Eslami Sarab, San Jose, CA (US); Nicholas Zehender, Menlo Park, CA (US)

(72) Inventors: Farshid Eslami Sarab, San Jose, CA (US); Nicholas Zehender, Menlo Park, CA (US)

(73) Assignee: NetApp, Inc., Sunnyvale, CA (US)

(21) Appl. No.: 13/253,798

(22) Filed: Oct. 5, 2011

(51) Int. Cl. G06F 17/30

(52) U.S. Cl. 707/690; 707/E17.01

(57) ABSTRACT

Methods and a processing system directed to a network assisted file system checker are described. In one embodiment the checker system is a network assisted checker that employs virtual storage devices that is storage is backed by files, and optionally the files backing the virtual storage devices may be remote files accessed over a network through a network file sharing protocol such as, but not limited to, NFS or CIFS. A device driver module introduces the virtual storage device to the local operating system supporting the checker process, and the device driver maps read and write requests made by the checker process to the virtual storage device onto files being supported by the network file sharing system.

### TECHNICAL FIELD

Some example embodiments relate generally to data storage, and more specifically, to systems and methods for performing checks of a file system used on a storage system.

### BACKGROUND

Today, data storage systems are becoming larger and integrated into business operations. Reliable data storage is now a business critical asset. However, with data storage systems now consisting of hundreds of disks, failures become more possible. As such, engineers are developing tools to diagnose problems as they occur and to fix these problems without forcing the storage system off-line. These tools improve system reliability and allow the twenty-four-seven data availability that is crucial for today's business applications.

As a result, tools for coping with possible system failures and recovering from them with minimal downtime are becoming necessary system components. One area of failure is the storage system file system. File systems organize the data stored on disks into a useable hierarchy of files and directories. In essence, the file system is the map that allows users and computer programs to find the location on the disk that has the data they need. Unfortunately, file systems are vulnerable to data corruption. A file system validation tool (e.g., a file system checker) is useful for avoiding data corruption by testing a file system's individual constituents, and repairing the individual constituents if necessary, to ensure that the file system is self-consistent. One such file system checker is UNIX File System Checker (FSCK). As a file system consistency checker, FSCK corrects inconsistencies in the on-disk format of a file system which can be caused by hardware failures and software bugs. Upon detecting a failure, running FSCK or any file system consistency checker works to prevent data loss that could be caused by file system inconsistencies.

However, as useful as these tools are, they are, in the end, support processes that must operate in a manner that avoids interfering with the main storage functions of the system. File systems for large storage systems can be large and efficiently checking these systems can be a cumbersome task, particularly as systems with corrupted file systems tend to be less stable and may crash during the file system check, or worse because of it. Moreover, file system checkers can generate large temporary files for storing status data, such as data on the portion of the file system that has been checked, which resources of the file system are free for use, and other status data. These files can be quite large relative to the storage space used to store data. Status files can sometimes require about thirty percent of the storage space used for the data. As such, there remains a need for file system checking systems that use reduced system resources and operate more reliably.

### SUMMARY

In one embodiment the systems and methods described herein include a checker system, and more particularly a network assisted checker that employs virtual storage devises, such as, but not being limited to, virtual disks, whose storage is backed by files, and optionally the files backing the virtual storage devices are remote files accessed through a network file sharing protocol such as, but not limited to, NFS or CIFS. A device driver module introduces the virtual storage device to the local operating system supporting the checker process, and the checker process will store status files on the virtual storage devices and make read and write requests to the status file on the virtual storage devices. The device driver receives the read and write requests and maps the requests onto files supported by the network file sharing system and which are used to provide backing to the virtual storage devices. The network file sharing system can take care of storing the files and making sure the required storage space is allocated for these files.

More particularly, the systems and methods may include a method of checking file system consistency, the method comprising operating a file system checker program on a client for checking the consistency of a file system, and operating a network file sharing server for sharing files over a network and having storage for a file system check status file. The method creates a virtual disk and introduces the virtual disk to the client to allow the client to generate a file system on the virtual disk, including a file system check status file. The method mounts a file system on the network file sharing server, and associates the storage and the files on the virtual disk including the file system check status file with files on the mounted system. The method processes file access requests from the file system checker program to read or write to the file system check status file on the virtual disk by sending the request to files in the mounted file system.

Optionally, the network file sharing server is an NFS server that exports an access point for accessing a file system of the NFS server. Preferably, the method isolates the virtual disk from being claimed by the client operating system for other processes, and to that end may set a unique disk type for the virtual disk to prevent the virtual disk from being aggregated for use as storage.

In another aspect, the systems and methods described herein include a system for checking the consistency of a file system, comprising a client having an operating system and a file system checker program for checking the consistency of a file system, a network file sharing server for sharing files over a network and having storage for a file system check status file, and a disk driver module configured to create a virtual disk and introduce the virtual disk to the client operating system and allow the operating system to generate a file system on the virtual disk, including a file system check status file. The disk driver, or another process, may also mount a file system on the network file sharing server, and process a read or write request from the file system checker program to read or write to the file system check status file on the virtual drive by sending the request to files in the mounted file system. The driver keeps an association between the virtual disk and the mounted files storing the information of the file system check status file.

Typically, the network file sharing server comprises an NFS server or a CIFS server, and more typically, the network file sharing server comprises an NFS server and the NFS server has an exported access point for accessing a file system of the NFS server. Optionally, the network file sharing system has storage space greater than ten percent, and sometime thirty percent of the size of the storage system associated with the file system being checked.

In still a further aspect, the systems and methods described herein allow for remote storage to be provided as a service for user of the network assisted file system checker. In this way, users can lease, purchase or contract for a level of service that provides the user with access to a network file sharing system that will provide enough storage to back the virtual drive used by the file system checker program. In one particular practice, the method provides a client with file system consistency checking, by providing the client with a file system checker program on a client for checking the consistency of a file system. The method operates on a remote server a network file sharing server for sharing files over a network and having storage for a file system check status file, and creates a virtual disk and introducing the virtual disk to the client and allowing the client to generate a file system on the virtual disk, the file system including a file system check status file. The method provides the client a device driver for allowing the virtual disk to mount a file system on the remote network file sharing server, and it associates files on the virtual disk including the file system check status file and the mounted system. The driver processes file access requests from the file system checker program to read or write to the file system check status file on the virtual disk by sending the request to files in the mounted file system.

Optionally, the method controls access of the device driver to the network file sharing server in response to a service level agreement.

### BRIEF DESCRIPTION OF THE DRAWINGS

The foregoing and other objects and advantages of the systems and methods described herein will be appreciated more fully from the following further description thereof, and some embodiments are illustrated by way of example and not limitation in the figures of the accompanying drawings in which;

FIG. 1 illustrates an example of a data repository;

FIG. 2 illustrates in more detail the system of FIG. 1 and depicts the file system check process for the file system;

FIG. 3 illustrates an example of an internal structure of a file system check system;

FIGS. 4A and B are flow charts of a general overview of a method, in accordance with an example embodiment, for file system checking;

FIG. 5 is a functional block diagram depicting a virtual disk driver layer mapping a virtual disk to a set of network files; and

FIG. 6 is a functional block diagram of alternative pathways for storing status data on the network files; and

FIG. 7 is a block diagram illustrating components of an example processing system able to perform operations according to instructions.

### DETAILED DESCRIPTION

To provide an overall understanding of the systems and methods described herein, certain illustrative embodiments will now be described, including systems and methods directed to a file system checker and in one particular embodiment, a system that uses network storage resources to facilitate a file system checking process. However, it will be understood by one of ordinary skill in the art that the systems and methods described herein can be adapted and modified for other suitable applications and that such other additions and modifications will not depart from the scope hereof. As such, examples merely typify possible variations. Individual components and functions are optional unless explicitly required, and the sequence of operations may vary. In the following description, for purposes of explanation, numerous specific details are set forth to provide a thorough understanding of example embodiments.

File system checking is process by which a program, typically referred to as a checker program, and in some particular embodiments where files are being verified, a file system checker, validates a file system, typically by testing the nodes of the file system for consistency with other nodes in the file system. A file system checker employs local disk space available on the machine it is running on to store temporary files that are generated during the file system check process. Usually, these files are stored in another aggregate on the same system. In some cases, however, this disk space is not available. For example, sometimes the file system checker is executing on a system with a small amount of free disk space and the file system checker lacks the physical storage space required for the temporary files that will be created during the validation process. In other cases, there are no verifiably uncorrupted aggregates on the system, thus making it unsafe to store any new data locally before the entire system has been checked for inconsistencies. This can be especially problematic in systems with a single aggregate, because if that aggregate becomes corrupted, then there is never another uncorrupted aggregate on which the file system checker can store temporary data.

If sufficient local disk space is unavailable, the file system checker cannot be run, and the storage system becomes vulnerable to file system inconsistencies. The systems and methods described herein use disk space on the network storage, often on a remote system, in place of local disk space, to provide storage space for the file system checker status files. Optionally, that storage space may be added as needed, such as by connecting a storage device, such as a hard-drive or a USB drive, to the network, or by using storage on an administrator's computer while the administrator runs the file system check process, or by accessing storage space provided as a service for the purpose of running the file system checker.

In particular, and as will be described more fully below, in one embodiment the file system checker system is a network assisted file system checker that employs virtual disks whose storage is backed by files, and optionally the files backing the virtual disks may be remote files accessed over a network through a network file sharing protocol such as, but not limited to, NFS or CIFS. A device driver module introduces the virtual disk to the local operating system supporting the file system checker process, and the device driver maps read and write requests made by the file system checker process to the virtual disk onto files being supported by the network file sharing system.

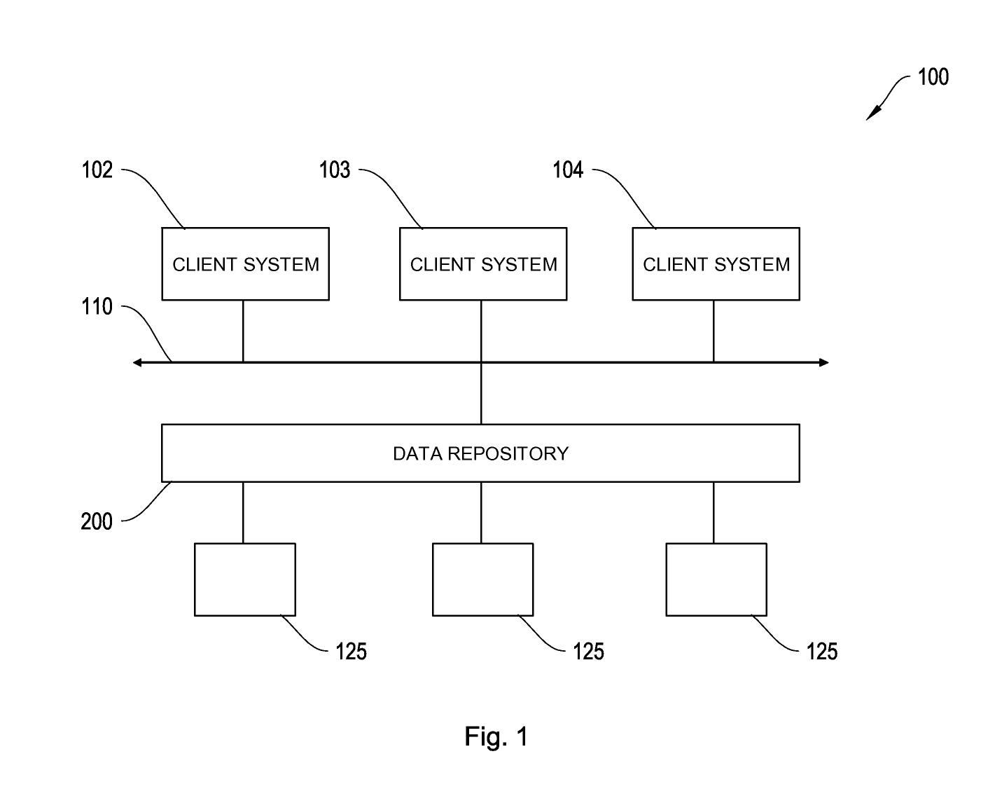

FIG. 1 illustrates an example of a “data repository” of the type that stores data and uses a file system. As used herein, “data repository” means a storage system or device for storing data. In the example shown, a data processing environment 100 includes multiple data processing systems 102-104 connected (e.g., attached) by a network 110 to a storage system data repository 200. In some example embodiments, the multiple data processing systems 102-104 are computer systems. In certain example embodiments, the network 110 is a wireless network. Alternatively, in other example embodiments, the network 110 is a wired network.

The storage system data repository 200 may include an operating system, a file system and physical storage. Optionally, it may include only one physical storage unit (e.g., a disk drive, or a flash memory drive). Alternatively, the data repository 200 may include multiple physical storage units 125 (e.g., several disk drives). According to some example embodiments, the data repository 200 behaves like a single physical storage unit from the viewpoint of external devices and users.

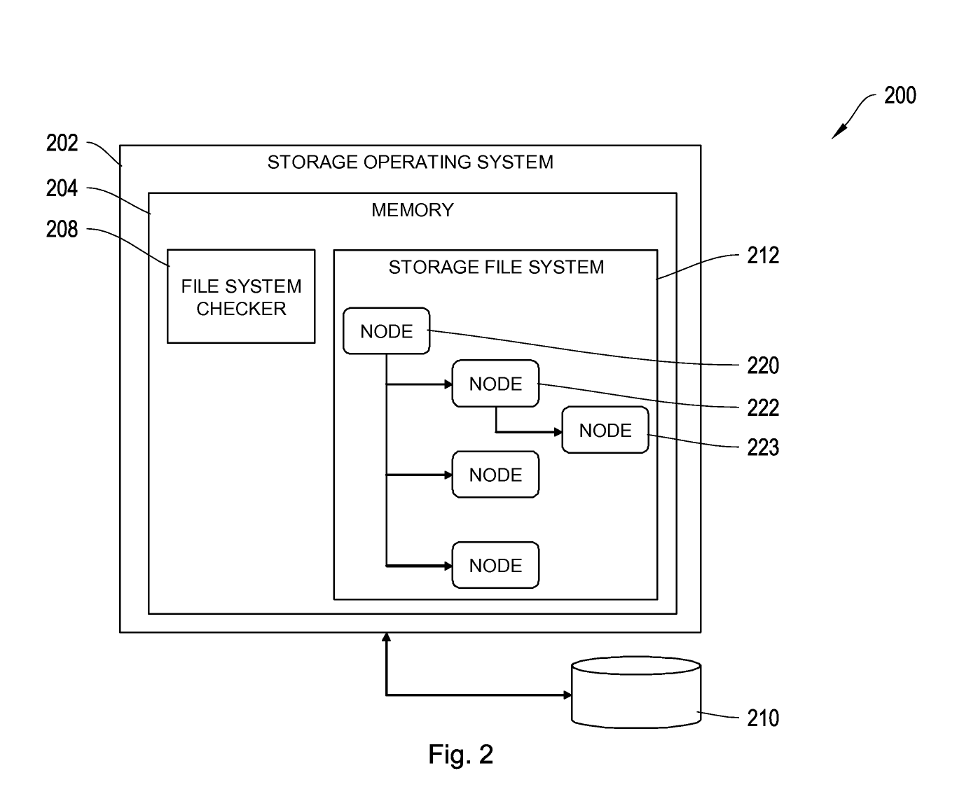

FIG. 2 illustrates an example of an internal structure of a storage system data repository data repository 200 that uses a hierarchical tree structure file system 212. Data can be stored using storage objects which for example can be streams, files and directories. In one embodiment, the storage objects are files and directories arranged as a tree structure file system, such as the system 212. As used herein, a “file system” is a logical structure for organizing data in a data repository. A file system enables external devices and users to access files in the data repository.

As presented to external devices and users, the storage objects, such as the file system 212, appears as a hierarchical tree structure composed of “files” and “directories.” As used herein, a “file” is a body of data. Examples of files include documents, images, music, movies, software programs, and databases. In this specification, a “directory” (also known as a “folder”) is a constituent of the file system that functions as a container for files and/or other directories (called “subdirectories” or “subfolders”). Similarly, a “subdirectory” may contain files or further subdirectories.

Internally, however, the data of files and directories are organized in a file system (e.g., file system 212) by data structures called “nodes” (e.g., nodes 220-223). In this specification, a “node” (e.g., node 220) is a data structure used to organize data in a file system. In many file systems (e.g. file system 200), a node (e.g., node 220) may be an “index node,” which is also known as an “mode.” Inodes serve the same function as nodes. Some file systems, however, use similar data structures but do not use the terms “node” or “mode.” As used herein, the term “node” includes all data structures used to organize data in a file system. Within a file system, a node (e.g., node 220) may represent, for example, a file, a directory, or an “access control list”, which will be understood as a list of users and their respective permissions to access a file or directory.

In the example shown, the file system 212 includes several nodes (e.g., nodes 220-223). Each node (e.g., node 220) is associated with two kinds of data: “metadata” and “referenced data.” As used herein, a node's “metadata” is information about that node and its referenced data. Examples of metadata include “node type,” “data length,” “epoch,” “link count,” “date,” and “time.” Node type refers to the function of the node within the file system (e.g., a file, a directory, or an ACL). A “data length” refers to the amount of data referenced by the node (e.g., node 220). In some embodiments, data length is measured using a number of bits or bytes. In the example of a directory node, one example of metadata is a “link count” (e.g., the number of subdirectories and/or junctions linked to that directory inode).

Another kind of data, a node's “referenced data” is information content associated with the node. For example, in the example of a file node, the referenced data is the contents of the file (e.g., words of a document, or entries in a database). In the example of an ACL node, the referenced data is the contents of the access control list (e.g., users and their respective permissions). A node's referenced data may include references to other nodes (see, e.g., node 223). For example, in the example of a directory node, the referenced data is the contents of the directory (e.g., files and subdirectories). Where a node's referenced data includes references to other nodes, the other nodes are called “downstream nodes” in this specification.

The storage files system 212 in one embodiment is part of the kernel of a storage operating system 202, and runs in the system memory 204, along with a file system checker process 208. The data repository 210 stores data organized under the storage file system 212, and the nodes 220, 221, and 223 provide the structure of the file system 212 and reference the data stored on the storage 210.

The storage device 210 depicted in FIG. 2 is shown as a single storage volume. However, in practice, it is commonly the case that the data repository 200 comprises a plurality of storage disks that are arranged or grouped into a number of aggregates by means of a suitable control system such as a RAID system. A storage system, like the system 200, running a storage operating system, such as for example Data ONTAP, typically controls multiple disks, most of which are grouped into some number of aggregates by means of RAID, or some other suitable means. Typically, one aggregate on a machine is designated as the root aggregate. Also typically, each aggregate contains some number of virtual volumes, and one is the root volume. These are the volumes which are accessible to users over the network 110 via protocols such as NFS and CIFS, or the logistical unit number (LUNs) accessible via (SAN) protocols. Such virtual volumes, such as the FlexVols virtual volumes provided by the assignee hereof, do not correspond to physical disks; instead storage resources are pooled together into aggregates and then divided up into virtual volumes. The disk blocks of a virtual volume can be allocated on demand, unlike blocks of a real disk, allowing for thin provisioning.

The storage operating system 202 can be any suitable storage operating system including the Data ONTAP operating system that can be run on different network appliances that will act as servers for storage systems including the Network Attached Storage (NAS) and Storage Area Network (SAN) and related protocols such as NFS and the Common Internet File System (CIFS). The storage file system 212 is depicted as running within the storage operating system 202. In one embodiment the file system may be the Wright Anywhere File Layout (WAFL), a file system produced by the assignee hereof.

In the depicted embodiment of FIG. 2 the storage file system 212 is loaded into the memory 204 of the system 200, but it represents data stored on the storage 210. Specifically, FIG. 2 depicts a portion of the file system 212 as containing a set of nodes 220 through 223. The nodes may contain logical blocks that provide references to data actually stored on the storage medium of the storage 210. For example, the referenced data may be the contents of a file, such as the words in a document or entries in a data base. In either case, the structure of the file system 212 shows that the data maintained by the file system 212, whether metadata or referenced data, is organized into a hierarchical tree structure that provides for an organization of the data and allows user to access data stored on the storage system 200. The data stored on the storage medium 210 needs to correctly correspond to the organization represented by the files system 212. Inconsistencies between the file system 212 representation and the data stored on the repository may result in errors and system failures.

File system checker 208 depicted in FIG. 2, can access the storage file system 212 to validate the file system 212, including validating the nodes 220 through 223 of that file system. Validating a given node may optionally involve validating its metadata or its referenced data. The referenced data is maintained on the data repository 200 and can be read and checked against the file system.

In a system with multiple storage disks, there is a possibility of a hardware or software failure. File systems need to be able to recover from any inconsistencies which are introduced by such failures. This is the task performed by the file system checker, or file system consistency checker, 208.

The file system checker 208 is generally run whenever a problem is detected with a file system such as file system 212, for example, such as when the system is turned on after an improper shutdown. The file system checker 208 may also be run periodically to check for inconsistencies which might not have caused a problem yet. One example of a file system checker is the FSCK consistency checker provided under the UNIX operating system. Another example is FSCK, a file system consistency checker that checks the file system, such as the file system 212, while that file system is on line and accessible. In either case, the file system consistency checkers examine the file system 212 to identify inconsistencies such as failure of a directory to contain a link to itself and its parent respectively, or the corruption of an in-use status flag indicating the in-use status of a data block on the storage medium in the repository 210, thus risking that data or file structure will be overwritten. Other types of file inconsistencies can be identified by the file system checker 208 and corrected for the purpose of avoiding harm to the data stored on the data repository 210. Although the file system checker 208 has been described as a file system consistency checker, it will be apparent to those of skill in the art that the file system checker 208 may be any type of file system checker that validates some characteristic of the storage system 200, such as the file system, the physical media of the storage disks that makes up the data repository 210. Thus, the systems and methods described herein may be used with any other system validation software that verifies the integrity of one or more features of the storage system 200.

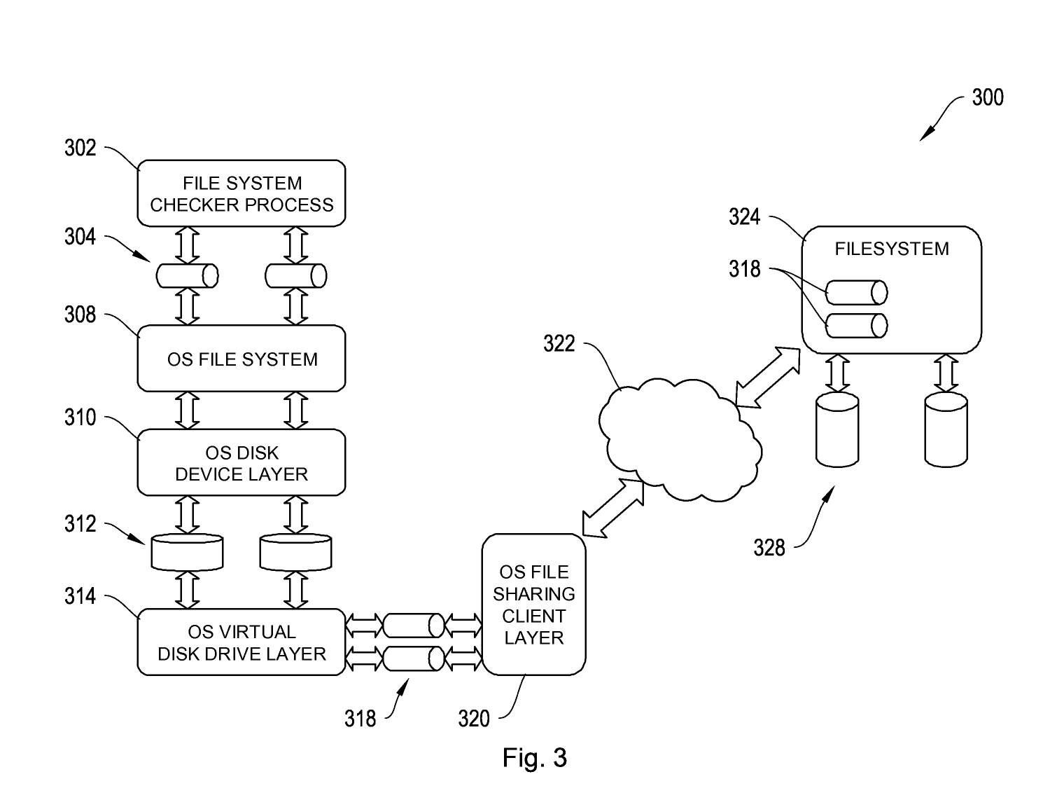

The file system checker 208, in the embodiment depicted above, is a network-assisted file system checker system that uses a network file sharing system to provide the file system checker 208 with access to storage at a location on the network, including locations remote from the server that is supporting the file system checker 208. FIG. 3 depicts in more detail a network assisted file system checker system 300.

In particular, FIG. 3 depicts an embodiment of the network assisted file system checker system 300 that includes a file system checker process 302, one or more status files 304, an operating system file system 308, an operating system disk device layer 310, one or more virtual disks 312, an operating system virtual disk drive layer 314, a plurality of files 318 to store the data of the virtual disks 312, a network file sharing client 320, a data network 322, and a network file sharing server 324 with storage disks 328.

The network assisted file system checker 300 depicted in FIG. 3 provides a file system checker process 302 with one or more virtual disks 312. In this depicted embodiment, virtual storage is provided by virtual disks 312. However, any suitable virtual device capable of providing storage may be employed. In other embodiments, virtual storage may include virtual flash memory, virtual optical or tape memory or a mix of virtual devices. The type of virtual device employed will vary, at least in part, based on the application at hand and those of skill in the art may select the virtual device or devices most suited for the application. The virtual disks 312 can be joined by the OS file system 308 such that the virtual disks are accessible to the OS file system 308 through the OS disk device layer 310. The virtual disks 312 are driven by a virtual disk drive layer 314 that will service the read and write requests from the file system checker process 302, as those read and write requests are passed through the OS file system 308 and OS disk device layer 310.

The virtual disk drive layer 314 can coordinate files created by the file system checker process 302 and stored on the virtual disks 312 with files 318 that are provided by the network file sharing server 324. In this way, the virtual disk drive layer 314 can coordinate files mapped on to the virtual disk 312 by the file system checker process 302 with files maintained by the network file sharing server 324. Data stored by the file system checker process 302 on to the virtual disk 312 will be transparently supported and maintained by the network file sharing server 324. The virtual disk 312 looks like any other disk to the OS File System 308, but rather than being a physical disk, the virtual disk exists as a file on the network file server 324.

The virtual disk can be set up by the network assisted file system checker 308, or any other process including the virtual device driver 314. In one practice, the virtual disk 312 is set up as a file that will be a sparse file, such that blocks will be allocated for the file on demand. This allows the file system checker 302 to create a file large enough for the biggest status files expected, and not worry about dynamic sizing or wasted space. The network assisted file system checker 302 informs the OS file system 308 about various properties of the virtual disk, such as its size and RPM. In one example, the disk size was set to 68 GB, which was large enough to store the status files for the expected tests run. Since the virtual disk 312 is backed by a file instead of a physical disk, a default, made-up value is used for RPM and several other properties which do not apply to a file. The virtual disk 312 was set to use a sector size of 520 bytes, in order to enable block checksums (where the last 8 bytes of a block contain the checksum of the first 512 bytes). Using a checksum protects the system 300 from data corruption, which may arise for example during network storage or transfer. If the status files were to become corrupted, the file system checker 302 could end up corrupting the file system being checked, which is file system 212 in FIG. 2.

The virtual disk's type, normally SATA or Fibre Channel, is set to a new, unique type. This isolates the virtual disk 312 from the OS File System 308 and more particularly prevents the OS File System 308 from accessing and taking control of the virtual disk 312 for other operations, such as for example, if a disk in a RAID array of another aggregate fails, and the OS File System 308 wants to find a spare disk to replace it, the virtual disk 312 should not be chosen for this purpose.

The network assisted file system checker 302 notifies the OS disk driver layer 310 that there is a “new disk”—the new virtual disk 312. The disk driver 310 processes this information, and eventually informs the OS file system 308 of the “new disk.” The network assisted file system checker 302 typically waits until the information about new disk is visible to the OS file system 308 before proceeding. Finally, the new disk is to be assigned to the node on which the network assisted file system checker 302 is running. Assigning a disk to a node sets that node (and only that node) to use the virtual disk 312 in aggregates. Once this step is complete, the network assisted file system checker 302 is finished setting up the virtual disk 312 and optionally can move on to making an aggregate and virtual volume on the disk 312.

The network assisted file system checker 302 may create a single disk RAID 0 aggregate using the new virtual disk 312. The file backing the virtual disk 312 will be protected by the RAID the network file server 324 employs. Optionally, the network assisted file system checker 302 could create multiple virtual disks 312 and set up a RAID 4 or RAID DP aggregate. RAID 0 may not be allowed on the OS File System 308, and this may require bypassing the restriction. Additionally, as the virtual disk is backed by a file, it will already be zeroed when it is created. Therefore, zeroing is disabled for the virtual disk 312.

The network assisted file system checker 302 can optionally create a large volume on the aggregate. As with the virtual disk 312, the network assisted file system checker 302 may create a volume which will be large enough for any situation, and rely on the sparse backing file to prevent this from unnecessarily degrading performance and wasting space.

Once the virtual disk 312 is set up and the network file sharing system 324 is mounted and available to the virtual disk drive 314, the virtual disk drive can begin mapping read and write operations to and from the virtual disk 312 to files stored on the network file sharing server 324. The device driver 314 creates files on the network file sharing server 324 and keeps a data structure that maps these network files to the storage on the virtual disk 312. The device driver 314 will receive, for example, write requests from the OS File System 308 for the file system checker 302 and the device driver will write to the network file server 324, typically an NFS server, and the network file server will take care of writing the data to the storage disks 328.

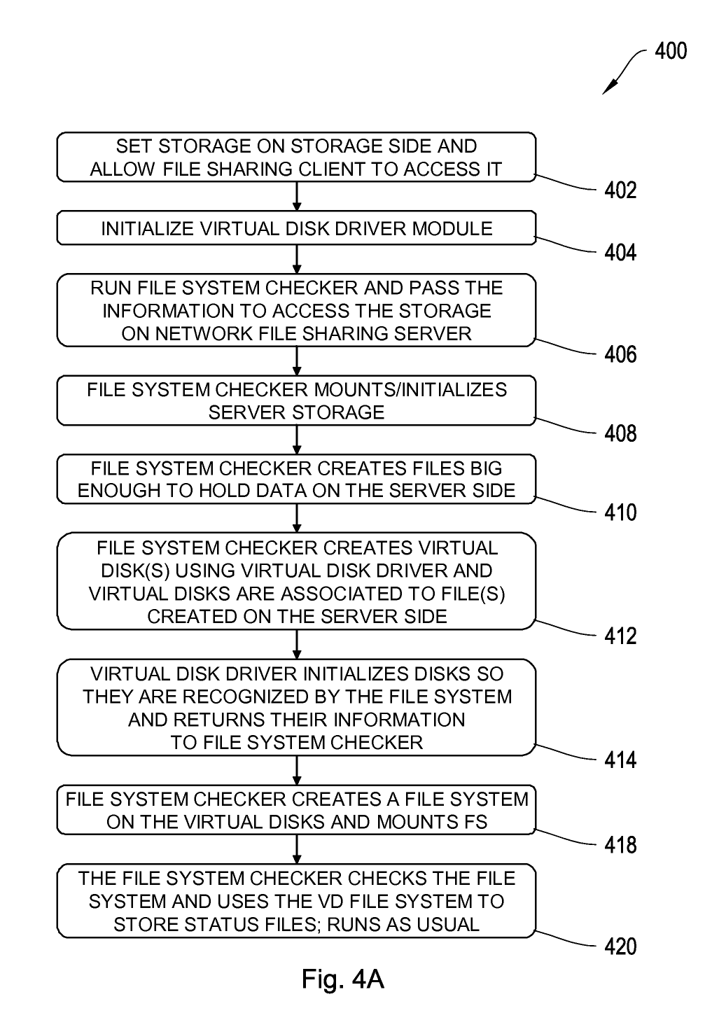

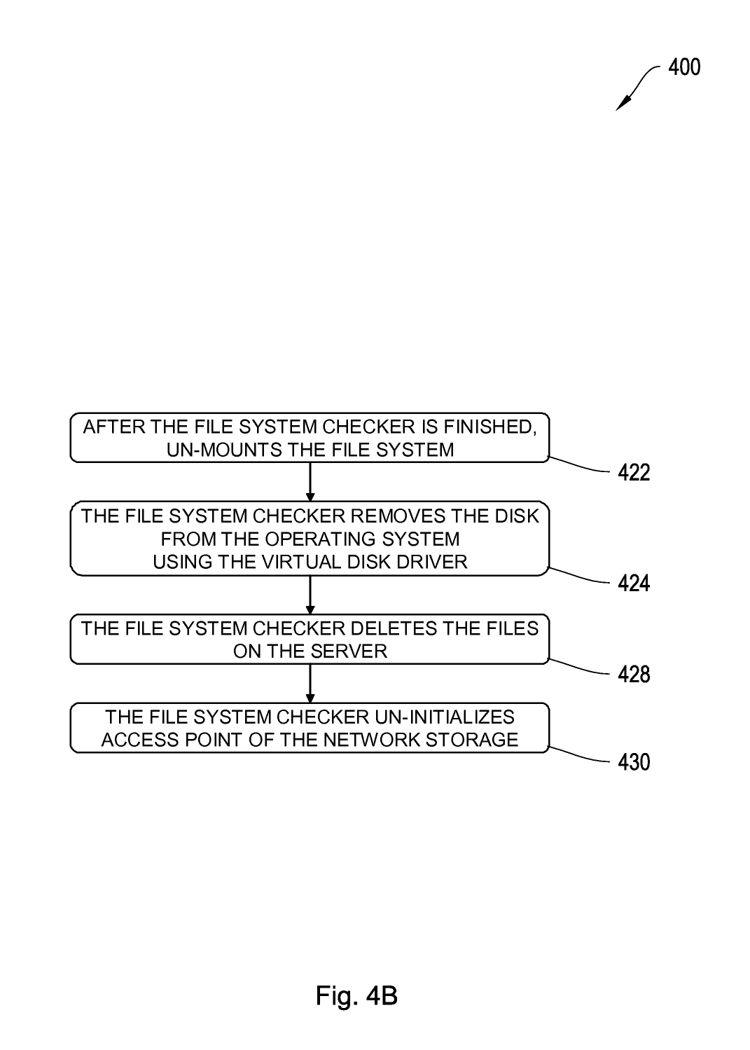

FIGS. 4A and 4B depict a process 400 for using a system, such as the depicted system 300 for performing network assisted file system checking. In particular, the process 400 starts in a step 402 in which storage space is set aside on a storage site, such as a remote storage site, and the client supporting the file system checker process is allowed to activate a network file sharing client that should access an exported network file sharing point provided by the network file sharing server.

After step 402 the process 400 proceeds to step 404 in which it initializes the virtual disk driver module executing on the client side. After step 404 the process 400 proceeds to step 406 wherein the process runs the file system checker and the information necessary to access the storage is provided to the file system checker process.

In step 408 the file system checker process mounts and initializes the access to the server storage provided by the network file sharing server. In step 410 the file system checker creates one or more files that are big enough to hold the status data that the file system checker program will generate. In step 412, the file system checker creates one or more virtual disks using the virtual disk driver. The virtual disks are associated to the files created by the file system checker in step 410.

In step 414, the virtual disk driver initializes the virtual disks so that the virtual disks are recognized by the file system supporting the file system checker process and the virtual disk driver returns the information about the virtual disk to the file system checker. In step 418 the file system checker creates a file system on the newly created virtual disks and mounts the newly created file system.

In step 420, the file system checker starts checking the file system, such as the file system 212, and uses the new file system on the virtual disks to store the status files created during the checking process. The file system checker then continues to run as usual using the virtual disks as storage space for status files.

FIG. 4B depicts that after running, the process 400 proceeds to step 422 wherein the file system checker, now finished, unmounts the file system on the virtual disks. In step 424 the file system checker removes the virtual disk from the operating system using the virtual disk driver. In step 428 the file system checker deletes the files on the network file sharing server. In step 430, the file system checker uninitializes the access point of the remote storage, typically by unmounting the NFS mount point.

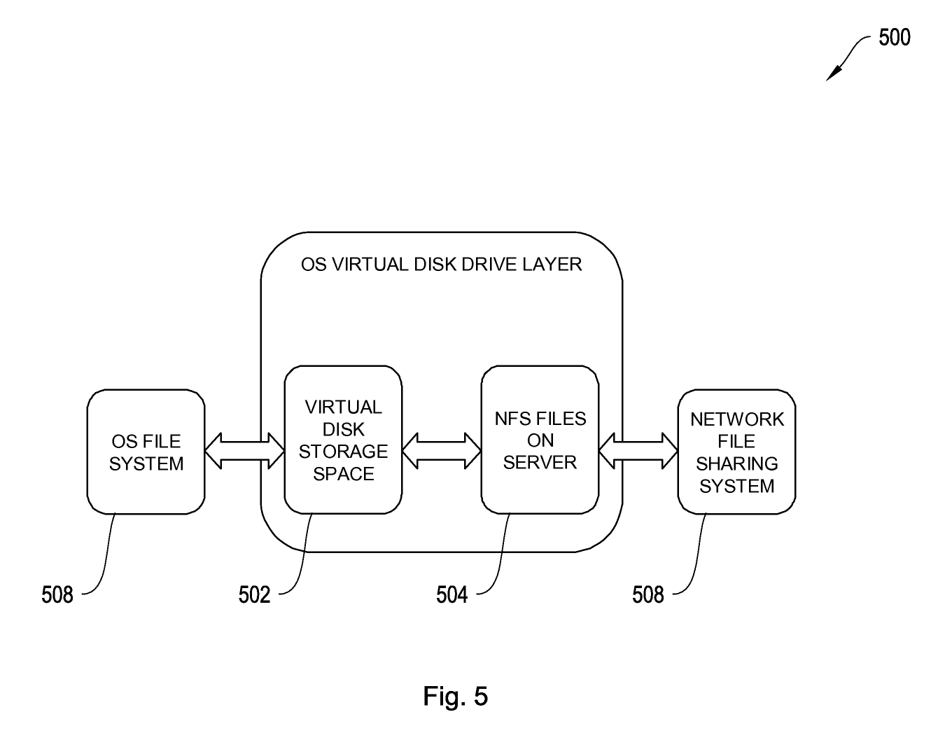

FIG. 5 depicts pictorially the operation of a virtual device driver 500 of the kind described with reference to FIG. 3. Specifically, FIG. 5 illustrates that the virtual device driver 500 that communicates with the OS File System 508, such as the Data ONTAP WAFL file system, available from the assignee hereof, and the network file sharing system 508, which may be an NFS server or a CIFS server. The virtual device driver responds to the read and write requests of the OS File System 508, which are requests to read and write data to and from one or more status files created by the network assisted file system checker 302. The network assisted file system checker 302 seeks to read and write data to the status file(s) it has stored on the virtual disk 312. Typically, the OS File system 308 has created a file system 502 for the virtual disk 312 that includes a directory structure and at least one file to act as the status file. The OS File System 308 passes, with the read and write requests, a handle to the file on the virtual disk 312 that relates to the request.

The virtual disk drive 502 creates a set of network files 504 after mounting the file system exported by the network file sharing system 324. The virtual device driver 500 translates write requests for files stored on the virtual disk storage space 502 to write requests for related files that are backing the storage space of the virtual disk. For example, in one embodiment the virtual disk 502 is set up as a block device and the OS File System 308 expects to access the virtual disk 502 as it would a physical block device. For example, the file system checker 302 may issue file write commands that the OS File System 308 will format into requests to write a data block to a block device and will deliver the request to the virtual device driver 500. In one optional practice, the virtual device driver 500 will set up queues of the data blocks that the File System 308 has requested to be written to the virtual disk 502. Data blocks in the queues will be given a handle that the OS File System 308 can use as a data block number that will “point” to the respective “data block” on the virtual disk. The device driver 500 can write the data blocks and the handles as data that is stored in the files created on the network file sharing program. The virtual device driver 500 can maintain a table that records the handles of the data blocks and the files storing the associated data blocks. The table may be used by the device driver to service read and write requests as it maps network file data with virtual disk data. Read requests are serviced in the reverse order, but with a similar process.

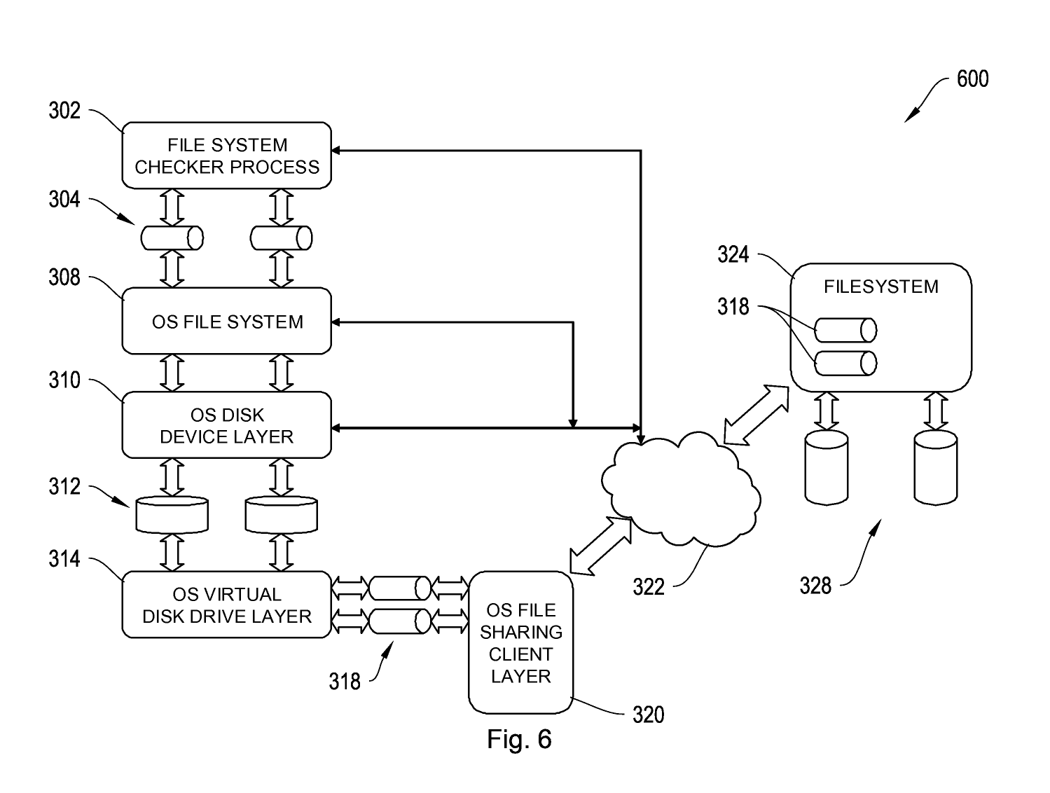

FIG. 6 depicts several alternative practices for using the files set up on the network file server 324. Specifically, FIG. 6 depicts three alternative processes for intercepting access to the data that the file system checker 302 needs. As can be seen from FIG. 6 these alternatives include allowing the file system checker program itself to create requests to access the remote files directly from the server 324. In another embodiment the file system checker program 302 reads and writes to the blocks of the file as usual. The blocks of the file can be stored in the cache of the client file system. When the client OS wants to flush or read the blocks it can use a file sharing protocol to read/write the blocks of the file. In still another embodiment, the file system on which the status files are saved can be a remotely mounted file system, or a cache of a remote file system, such NetApp FlexCache. These provide alternatives to using virtual disks backed by remote storage to store the files.

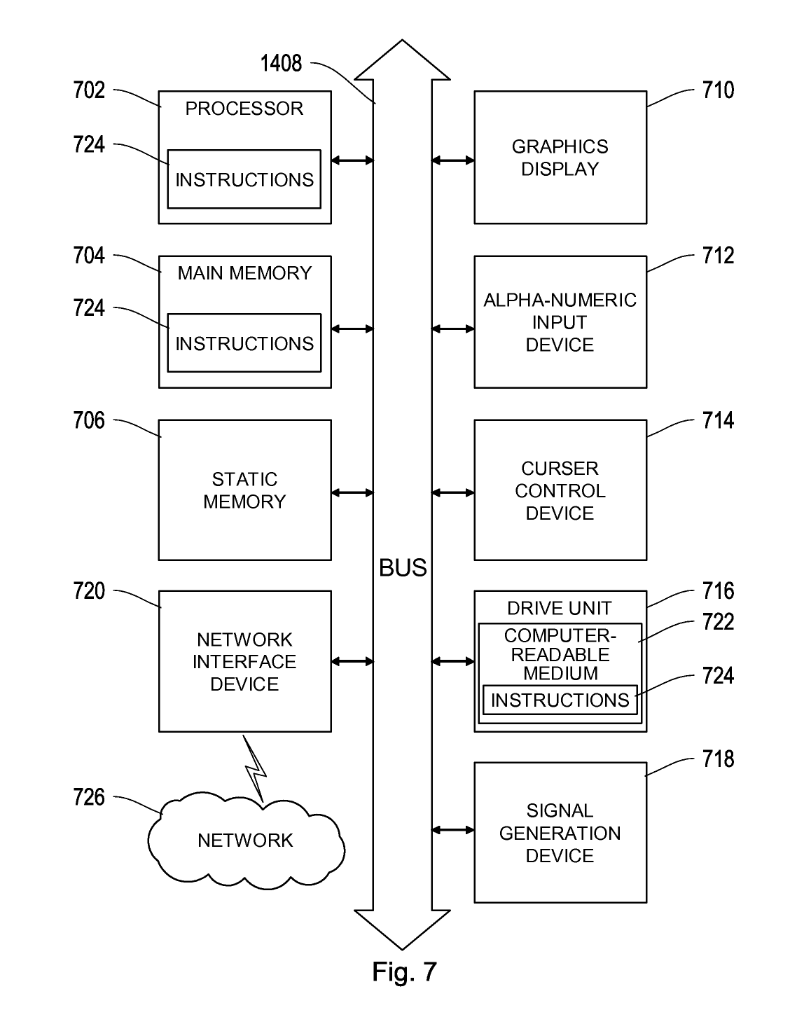

FIG. 7 shows a diagrammatic representation of processing system in the example form of a machine 700 (e.g., a computer system, or a computing device) within which a set of instructions 724 for causing the machine to perform any one or more of the methodologies discussed herein may be executed. In alternative embodiments, the machine operates as a standalone device or may be connected (e.g., networked) to other machines.

In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a smartphone, a web appliance, a network router, switch or bridge, or any machine capable of executing a set of instructions 724 (sequential or otherwise) that specify actions to be taken by that machine. Further, while only a single machine is illustrated, the term “machine” shall also be taken to include any collection of machines that individually or jointly execute a set (or multiple sets) of instructions 724 to perform any one or more of the methodologies discussed herein.

The example machine 700 includes a processor 702 (e.g., a central processing unit (CPU), a graphics processing unit (GPU), a digital signal processor (DSP), application specific integrated circuits (ASICs), radio-frequency integrated circuits (RFICs), or any combination of these), a main memory 704, and a static memory 706, which communicate with each other via a bus 708.

The drive unit 716 includes a machine-readable medium 722 on which is stored one or more sets of instructions 724 (e.g., software or firmware) embodying any one or more of the methodologies or functions described herein. The set of instructions 724 may also reside, completely or at least partially, within the main memory 704 and/or within the processor 702 during execution thereof by the computer system 700, the main memory 704 and the processor 702 also constituting machine-readable media.

The set of instructions 724 may be transmitted or received over a network 726 via the network interface device 720. For the purposes of this specification, a “module” includes an identifiable portion of code or data or computational object to achieve a particular function, operation, processing, or procedure

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Although certain figures above graphically depict the network assisted file system checker as functional block elements, it will be apparent to one of ordinary skill in the art that these elements can be realized as computer programs or portions of computer programs that are capable of running on the data processor platform 702 to thereby configure the data processor 702 as a system according to the invention. Moreover, although the figures may depict the system as an integrated unit, it will be apparent to those or ordinary skill in the art that this is only one embodiment, and that the systems and methods described herein can be distributed in many different ways and with different configurations.

As discussed above, the network assisted file system checker system can be realized as a software component operating on a conventional data processing system such as a UNIX workstation. In that embodiment, the network assisted file system checker system can be implemented as a C language computer program, or a computer program written in any high level language including C++, Fortran, Java or BASIC. Additionally, in an embodiment where microcontrollers or DSPs are employed, the network assisted file system checker system can be realized as a computer program written in microcode or written in a high level language and compiled down to microcode that can be executed on the platform employed. The development of such systems is known to those of skill in the art

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the example configurations may be implemented as a combined structure or component. Similarly, structures and functionality presented a single component may be implemented as separate components. These and other variations, modifications, additions, and improvements fall within the scope of the invention(s).

What is claimed is:

1. A method of checking file system consistency, the method comprising:
operating a checker program on a client for checking the consistency of a file system,
operating a network file sharing server for sharing files over a network and having storage for a file system check status file,
creating a virtual device and introducing the virtual device to the client and allowing the client to generate a file system on the virtual device, the file system including a file system check status file,
mounting a file system on the network file sharing server, and
associating files on the virtual device including the file system check status file and the mounted system, and
processing a file access request from the checker program to read or write to the file system check status file on the virtual device by sending the request to files in the mounted file system.

2. The method of claim 1, wherein the network file sharing server is an NFS server.

3. The method of claim 2, wherein the NFS server exports an access point for accessing a file system of the NFS server.

4. The method of claim 1, further comprising
isolating the virtual device from being claimed by the client operating system for other processes.

5. The method of claim 4, wherein
isolating includes setting a unique disk type for the virtual device to prevent the virtual device from being aggregated for use as storage.

6. The method of claim 1 further comprising:
creating a single disk RAID 0 aggregate using the virtual device.

7. A system for checking the consistency of a file system, comprising
a client having an operating system and a checker program for checking the consistency of a file system,
a network file sharing server for sharing files over a network and having storage for a file system check status file,
a device driver module configured to
create a virtual device and introduce the virtual device to the client operating system and allow the operating system to generate a file system on the virtual device, the file system including a file system check status file,
mount a file system on the network file sharing server, and
processing a read or write request from the checker program to read or write to the file system check status file on the virtual device by sending the request to files in the mounted file system, the device driver keeping an association between the virtual device and mounted files storing information of the file system check status file.

8. The system of claim 7, wherein the network file sharing server comprises an NFS server or a CIFS server.

9. The system of claim 8, wherein the network file sharing server comprises an NFS server and the NFS server has an exported access point for accessing a file system of the NFS server.

10. The system of claim 7, further comprising
the virtual device isolated from being claimed by the client operating system for other processes.

11. The system of claim 10, wherein
the isolated virtual device having a unique disk type for preventing the virtual device from being aggregated for use as storage.

12. The system of claim 7 further comprising:
a single disk RAID 0 aggregate formed from the virtual device.

13. The system of claim 7, wherein the network file sharing system has storage space greater than ten percent of the file system being checked.

14. The system of claim 7, wherein the network file sharing system has storage on a storage device being remote from the client.

15. A method of providing a client with file system consistency checking, the method comprising:
providing the client with a checker program on a client for checking the consistency of a file system,
operating on a remote server a network file sharing server for sharing files over a network and having storage for a file system check status file,
creating a virtual disk device and introducing the virtual disk device to the client and allowing the client to generate a file system on the virtual disk device, the file system including a file system check status file, and
providing the client a device driver for
allowing the virtual disk device to mount a file system on the remote network file sharing server,
associate files on the virtual disk device including the file system check status file and the mounted system, and
process file access requests from the checker program to read or write to the file system check status file on the virtual disk device by sending the request to files in the mounted file system.

16. A method according to claim 15, further comprising
controlling access of the device driver to the network file sharing server in response to a service level agreement.

17. A method according to claim 15, further comprising
setting a checksum parameter for the virtual disk device to provide a checksum value to detect data corruption in data stored by the network file sharing server.

18. A method according to claim 15, further comprising
creating a single disk RAID 0 aggregate using the virtual disk device.

19. A method according to claim 15, further comprising
disabling zeroing of mounted disks for the virtual disk device.

20. A method according to claim 15, further comprising
assigning the virtual disk to the client on which the checker program is running.

21. A method according to claim 15, wherein operating a network file sharing server for sharing files includes operating an NFS server for storing files of a server being remote from the client.
